(19) United States
(12) Patent Application Publication
(10) Pub. No.: US 2003/0010220 A1
(43) Pub. Date: Jan. 16, 2003

(54) Vending machine for a single-piece heated product

(76) Inventor: Kai Janssen, Edewecht (DE)

Correspondence Address: ALIX YALE & RISTAS LLP, 750 MAIN STREET, SUITE 1400, HARTFORD, CT, 06103, US

(21) Appl. No.: 10/181,861

(22) PCT Filed: Jan. 17, 2001
(86) PCT No.: PCT/EP01/00506

(30) Foreign Application Priority Data
Jan. 20, 2000 (EP) 00101082.6

(51) Int. Cl. A23B 4/00

(52) U.S. Cl. 99/471

(57) ABSTRACT

The invention relates to a vending machine for single-piece heated products, for example, snack sausages, comprising a magazine and a delivery path (6, 7, 8). A heating device (7) equipped with a wave resonator (41) is provided in a descending section of the delivery path and is delimited underneath by a switchable blocking element (50). The blocking element is designed as a load-sensitive sensor that detects the presence/delivery of a product.

Verkaufsautomat für stückige Heissprodukte, beispiels-weise Snack-Wüirstchen, mit einem Magazin und einem Abgabeweg (6, 7, 8). In einem fallend angeordneten Abschnitt des Abgabewegs ist eine Erhitzungseinrichtung (7) mit einem Wellenresonator (41) vorgesehen, die unterseits von einem schaltbaren Sperrelement (50) begrenzt ist. Das Sperrelement ist als lastempfindlicher Anwesenheits-/Abgabe-Sensor ausgebildet.

The invention relates to a vending machine for single-piece heated products and to a method of operating the same. FR-A-2458851 and DE-C-933666 disclose a vending machine which contains a magazine for a multiplicity of products, a discharge path for discharging a product selected by the customer, and a heating device. The heating device is a descending section, provided with a wave resonator, of the discharge path, which is bounded on the underside by a switchable flap. As soon as a product has been selected, released from the associated magazine compartment and passed into the discharge path under the action of its gravitational force, it is secured by the flap in the region of the heating device, until it has reached the desired temperature, and is then released for discharge purposes. The heating device is switched on here by the control signal, which also causes the product to be conveyed out of the magazine into the heating device. This is disadvantageous when the relevant magazine compartment is empty.

The object of the invention is thus for the vending machine specified in the preamble of claim 1 to be improved in terms of the reliability and cost-effectiveness of its operation. The solution according to the invention is provided by the characterizing features of claim 1 and preferably those of the subclaims.

Provision is accordingly made for the blocking element, which secures the product in the heating device, to be designed as a load-sensitive sensor for sensing the presence of a product and for controlling the heating device.

In the case of a preferred configuration of the invention, the blocking element is a downwardly opening flap which is closed in the rest position and is forced into a first closing position by a spring force or weight which is lower than the product weight. It has a second, lower-level closing position, which is defined by a stop. The blocking element interacts with a signal transmitter in the first and/or the second closing position. As long as the heating device is empty and the blocking element is not subjected to loading, the blocking element is located in the first closing position. If a product drops into the heating device, the blocking element is subjected to loading and passes into the second closing position. The signal transmitter here changes its switching position and thus signals the presence of the product. It forms both a presence sensor for the operation of the heating device and a discharge sensor for controlling the magazine.

The stop, which defines the second closing position, is expediently formed by a switchable catch, which is drawn back in order to release the product when the heating operation has been completed. The control device, which controls both the heating device and the blocking element, is expediently designed such that, the blocking element is only opened once a predetermined period of time has elapsed once the heating device has been switched off. This makes it possible to ensure that secondary processes which are associated with the product heating and subside thereafter are no longer detectable when the product is discharged to the customer.

If a non-heated product is to be discharged, this is also secured in the discharge path by the blocking element. On the one hand, this serves for the functioning of the discharge sensor and, on the other hand, the dropping action of the product is thus braked.

The invention is explained in more detail hereinbelow with reference to the drawing, which illustrates an advantageous exemplary embodiment and in which:

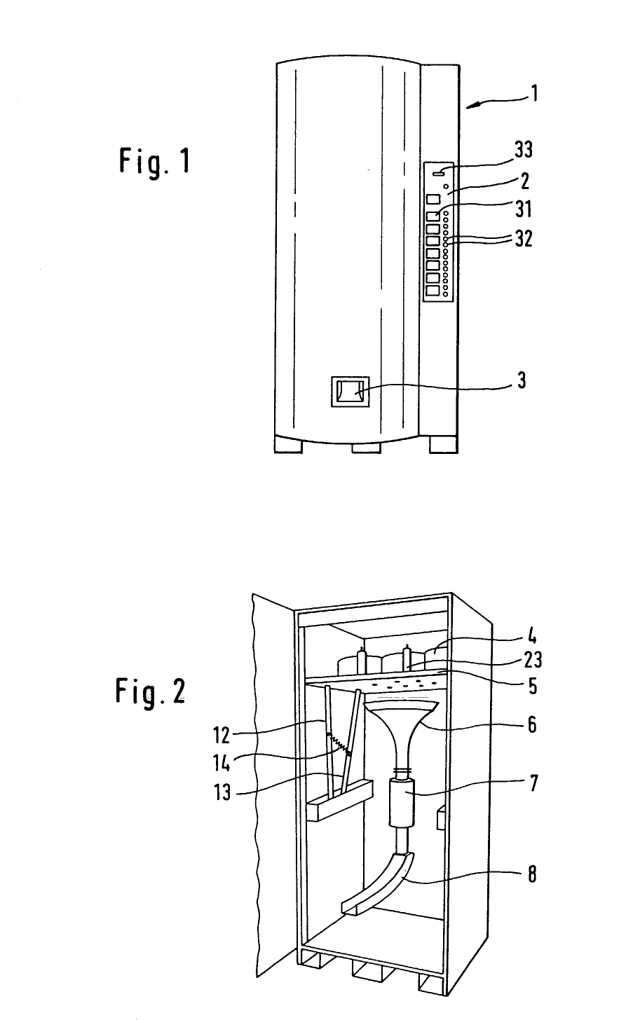

FIG. 1 shows a front view of the unit in the closed state,

FIG. 2 shows an oblique view of the unit, from the front, in the open state in the operating position,

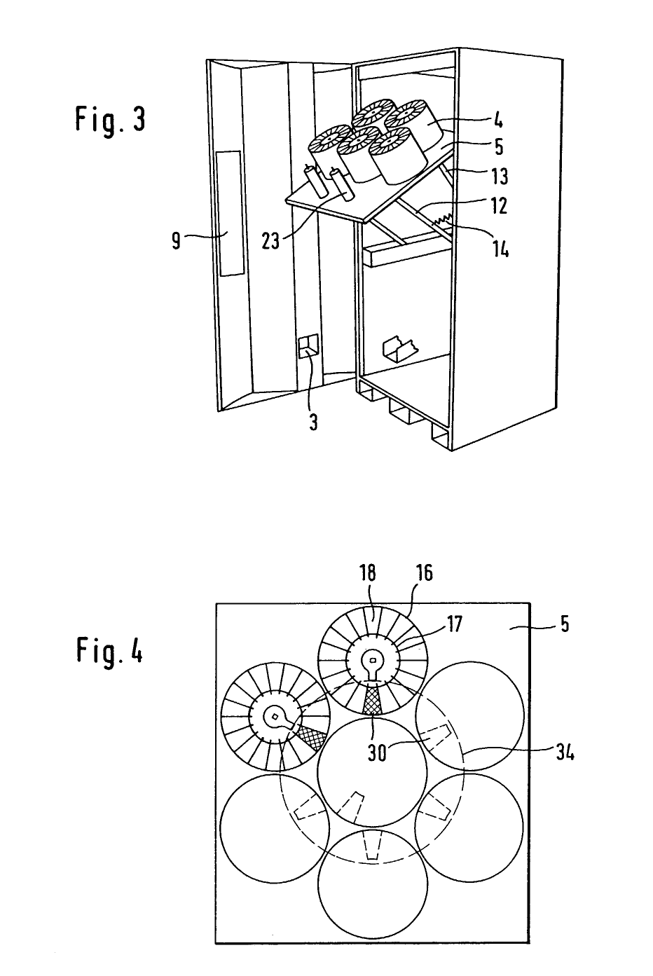

FIG. 3 shows an oblique view of the unit, from the front, in the filling position,

FIG. 4 shows a plan view of the magazine,

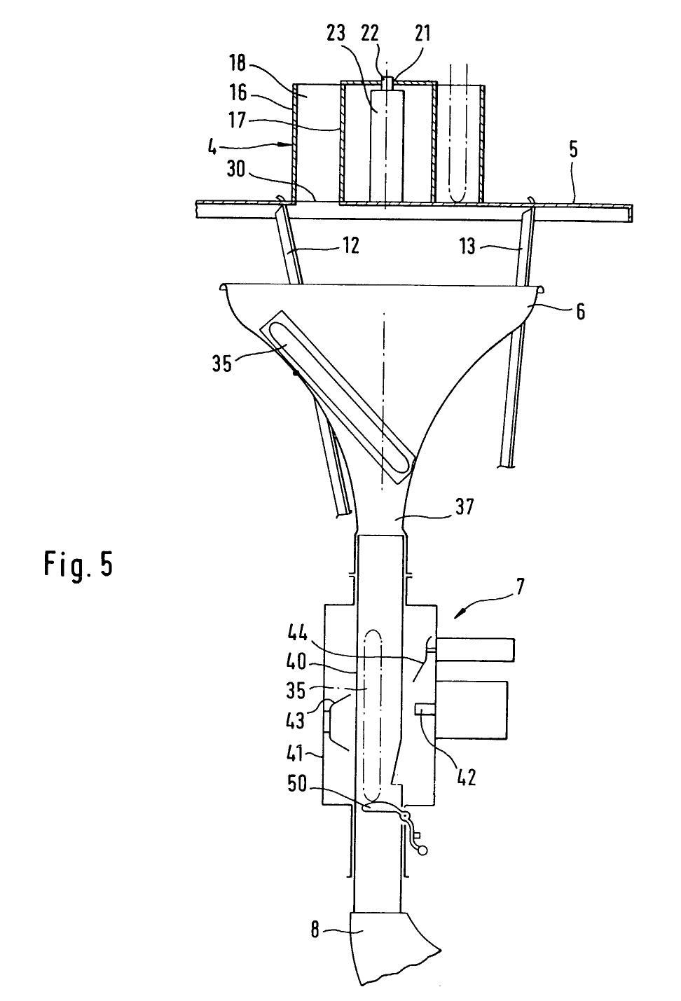

FIG. 5 shows a schematic sectional illustration of the essential functional elements, and

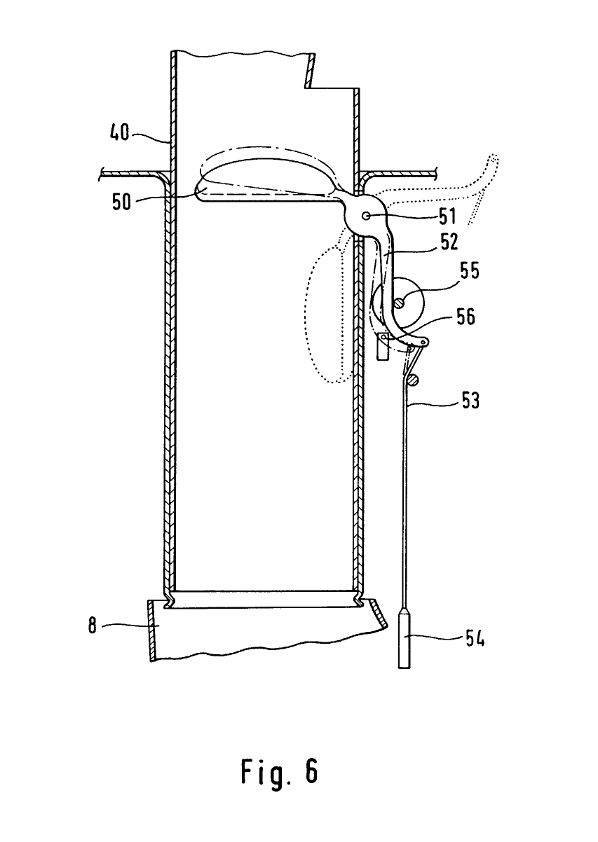

FIG. 6 shows a section through the discharge path in the region of the blocking element.

The vending machine is enclosed by a cabinet-like housing 1. This has, in its front, an operating panel 2 and a removal pan 3 for removing the selected product. Opening the door, which forms the front side, results in the view of FIG. 2, in which, for the sake of simplicity, those structural parts which serve for retaining the functional parts described hereinbelow have been omitted.

Situated at the uppermost location within the cabinet is the magazine, which is formed by a plurality of magazine drums 4 on a magazine panel 5. Provided beneath the magazine panel 5 is a hopper 6, which intercepts the selected product, released from one of the magazine drums 4, and guides it into a heating device 7, from which it passes into the removal pan 3 via a chute 8. The conveying path formed by the hopper 6 of the heating device 7 of the chute 8 and of the removal pan 3 is referred to in combined form as the discharge path. The functional interaction between the operating elements of the panel 2 and the magazine and/or discharge path is determined by a control device 9.

The magazine panel 5 rests on two pairs of pendulum supports 12, 13 which, by way of a spring 14, provide the magazine panel 5, in a bistable manner, with two end positions, namely, on the one hand, the approximately horizontal operating position within the cabinet, this being shown in FIG. 2, and the inclined position in which it is displaced forward out of the cabinet and the magazine is more easily accessible for filling and maintenance purposes, this being illustrated in FIG. 3.

The magazine panel 5 accommodates seven magazine drums 4, namely one magazine drum arranged in the center and six magazine drums positioned uniformly around the latter. This results in good utilization of space. Each magazine drum 4 contains a closed ring of magazine compartments 18 between a cylindrical outer wall 16 and a cylindrical inner wall 17.

The magazine drums rest on the magazine panel 5 and are centered, and driven in rotation, by a coupling stub 22 which fits into a coupling opening 21 and projects upward out of a drive column 23. This drive column contains a gear motor, of which the output shaft is connected to the coupling stub 22. FIGS. 2 and 3 show two such drive columns 23 without the magazine drums 4 positioned thereon.

Each magazine drum is assigned, on the operating panel 2, a nameplate 31 indicating the product which is contained in each case. Also provided for each of these nameplates 31 are two buttons 32 which can be used by the customer to specify whether he/she would like the respective product cold or heated. As soon as the customer has selected a product and its temperature state, after inserting money into the slot 33 and selecting one of the buttons 32, the control device 9 causes the relevant magazine drum 4 to rotate until a filled magazine compartment 18 is located above a discharge opening 30 in the magazine panel 5. The product then drops through the opening 30 into the discharge path.

The discharge openings 30 are located within the intercepting circle 34 (FIG. 4) of the hopper 6. The product 35, dropping out of any discharge opening 30, is thus reliably intercepted by the hopper 6, which passes it on to the heating device 7.

In the heating device 7, the discharge path is formed by a tube 40 made of a suitable dielectric, for example plastic. This tube 40 is enclosed by a round resonator 41 for microwaves, into which the antenna 42 of a magnetron projects. Suitable non-removable reflectors 43 and/or moveable reflectors 44 may be provided in order to ensure a uniformly distribution of energy in the region of the product 35 indicated by chain-dotted lines.

The position of the product is determined by a flap 50, which is always closed when the product is released from the magazine. The product is thus intercepted in each case in the heating station.

As FIG. 6 shows, the flap 50 is mounted at 51, in the vicinity of the wall of the tube 40, such that it can be pivoted about a horizontal pin, in order for it to be possible to assume, on the one hand, the blocking position, and, on the other hand, the opening position, which is indicated by dotted lines and in which the body of the flap butts, for example, against the tube wall, parallel to the latter, in order to leave a maximum through-passage cross section free. Above the flap, the tube 40 contains an inner protrusion 39, which leads the product past the open flap 50. On the far side of the pivot pin 51, the flap is connected to an arm 52, of which the end bears a weight 54 directly or via a filament connection 53. Instead of this, it would also be possible for the flap to be connected to a spring. The weight 54 or the spring is of such a magnitude that, and is arranged such that, the flap 50 is thus reliably kept in the blocking position as long as it is not subjected to loading by the product. On the other hand, the weight is low enough for the flap to open reliably under the weight of the product in order to let it through. In order that the product is temporarily secured in the heating device, there is provided a magnetic catch 55 which, in the state indicated in FIG. 6, secures the flap lever 52 in the blocking position and can be drawn back (transversely to the plane of the drawing) in order to release said flap lever.

As long as the flap 50 is not subjected to loading, it is located in the end position shown by chain-dotted lines. The magnetic catch 55 is arranged at a certain distance from the position in which the flap lever 52 is located in this end position. As soon as the flap is subjected to loading by the product, it thus pivots to the extent where it is secured by the catch 55, into the position which is depicted by solid lines. The difference between these two positions (depicted by chain-dotted lines and solid lines) is utilized in order to monitor the presence of the product. For this purpose, a sensor 56, for example a light barrier or a magnetic switch, is arranged in that region in which the flap lever 52 is located in its end position (chain-dotted lines). The switching state of this sensor changes as soon as the flap passes out of its end position, depicted by chain-dotted lines, into the catch-locking position, shown by solid lines. The signal which the sensor 56 emits in the latter case is evaluated by the control device as indicating the presence of a product.

The signal is important, on the one hand, for the operation of the heating device 7. It is only when there is a presence signal that the control device allows the heating device to be switched on. The signal is also important for controlling the magazine, because it indicates that a product has been discharged; it thus forms a discharge signal, which is used by the control device for controlling the magazine. As soon as a customer has requested a product, the product-containing drum is rotated in steps until the discharge signal takes place.

If the customer has requested the product in the cold state, then the flap 50 is opened immediately after the presence/discharge signal has taken place, by the magnetic catch 55 being drawn back. If the customer has requested the product in the hot state, then the magnetic catch 55 remains temporarily closed. The heating device is switched on for a predetermined period of time. Thereafter, a further predetermined period of time is allowed to pass until the catch 55 is drawn back, this allowing effects which may be associated with the heating operation (for example swelling of the packaging) to subside before the product is released for removal purposes.

1. A vending machine for a single-piece heated product, having a magazine (4, 5), a discharge path (6, 7, 8, 3) and a heating device (7), which is a descending section, provided with a wave resonator (41), of the discharge path, which is bounded on the underside by a switchable blocking element (50), characterized in that the blocking element (50) is designed as a load-sensitive sensor for sensing the presence of a product and for controlling the heating device (7).

2. The vending machine as claimed in claim 1, characterized in that the heating device (7) is a microwave resonator.

3. The vending machine as claimed in claim 1 or 2, characterized in that the blocking element (50) is a downwardly opening flap which is closed in the rest position.

4. The vending machine as claimed in claim 2 or 3, characterized in that the blocking element (50) is forced into a first closing position by a spring force or weight which is lower than the product weight, and has a second, lower-level closing position defined by a stop (55), said blocking element interacting with a signal transmitter (56) in the first and/or second position.

5. The vending machine as claimed in claim 4, characterized in that the stop is formed by a switchable catch (55).

6. The vending machine as claimed in one of claims 1 to 5, characterized in that there is provided a control device (9) which interacts with the blocking element (50) and the heating device (7) and is designed such that, once a predetermined period of time has elapsed once the heating device (7) has been switched off, the blocking element (50) is switched into its opening position.

7. The vending machine as claimed in one of claims 1 to 6, characterized in that it is designed for alternatively discharging non-heated products.

8. A method of dispensing an elongate heated product, such as snack sausages, from a vending machine, in the case of which the individually packaged product is stored in the cold state, is temporarily secured in a heating unit following discharge from the magazine in its longitudinal direction, and is then dispensed, characterized in that, once the heating device of the heating unit has been switched off, the product is still secured therein for a predetermined period of time.
